(19) United States
(12) Patent Application Publication
(10) Pub. No.: US 2017/0276098 A1
(43) Pub. Date: Sep. 28, 2017

(54) INTERNAL COMBUSTION ENGINE

(71) Applicant: TOYOTA JIDOSHA KABUSHIKI KAISHA, Toyota-shi (JP)

(72) Inventors: Hiroyuki TANAKA, Mishima-shi (JP); Shintaro HOTTA, Susono-shi (JP)

(73) Assignee: TOYOTA JIDOSHA KABUSHIKI KAISHA, Toyota-shi (JP)

(21) Appl. No.: 15/468,534

(22) Filed: Mar. 24, 2017

(30) Foreign Application Priority Data
Mar. 28, 2016 (JP) 2016-063501

(51) Int. Cl. F02M 31/20; F02D 41/30

(52) U.S. Cl. CPC F02M 31/205; F02D 41/30; F02D 2200/02

(57) ABSTRACT

When an internal combustion engine operates in a stoichiometric mode, a control apparatus operates a cooling system so that the temperature of intake air becomes 45° C. When the internal combustion engine operates in a lean mode, the control apparatus operates the cooling system so that the temperature of intake air becomes 35° C. Also, the control apparatus calculates a crank angle period from an ignition timing until a crank angle at which a mass fraction burned becomes 10% and adjusts a fuel injection amount so that the SA-CA10 coincides with a target SA-CA10. Then, the control apparatus sets the target SA-CA10 short immediately after switching from the stoichiometric mode to the lean mode and extends the target SA-CA10 in accordance with a decrease in the temperature of intake air.

### CROSS-REFERENCE TO RELATED APPLICATION

This application is based on and claims the benefit of Japanese Patent Application No. 2016-063501, filed on Mar. 28, 2016, which is incorporated by reference herein in its entirety.

### BACKGROUND

Field of the Disclosure

The present disclosure relates to an internal combustion engine, and more particularly to an internal combustion engine that, in accordance with an operating region, switches between a stoichiometric mode in which the engine performs operation at the theoretical air-fuel ratio, and a lean mode in which the engine performs operation at an air-fuel ratio that is leaner in fuel than the theoretical air-fuel ratio.

Background Art

JP 2015-094339A discloses that, when an internal combustion engine operates in a lean mode, a SA-CA10 that is a parameter representing ignition delay is calculated based on a signal of a combustion pressure sensor and a fuel injection amount is adjusted so that the SA-CA10 coincides with the target value thereof. The SA-CA10 is defined as a crank angle period from an ignition timing (SA) until a crank angle (CA10) at which a mass fraction burned becomes 10%. The SA-CA10 has a correlation with an air-fuel ratio, especially a limit air-fuel ratio at which lean combustion is available (an air-fuel ratio at which torque fluctuation reaches a limit from a viewpoint of drivability).

Thus, by setting a target value of the SA-CA10 adequately by an adaptation beforehand and adjusting a fuel injection amount by feedback control so that the SA-CA10 becomes the target value, an air-fuel ratio can be controlled to the limit air-fuel ratio automatically.

Note that, in addition to the above described patent literature, JP 2005-233116 A and JP 2008-255884 A may be mentioned as examples of literature describing the state-of-the-art at the time of filing the present application.

### SUMMARY OF THE DISCLOSURE

An intake air temperature (to be exact, a temperature of intake air that enters into a combustion chamber) influences the correlation that is established between a SA-CA10 and an air-fuel ratio, which will be discussed later in detail. That is, when the intake air temperature is different, the air-fuel ratio obtained by fuel injection amount control based on the SA-CA10 becomes different even if the SA-CA10 is the same. Thus, in addition to the fuel injection amount control based on the SA-CA10, active control of the intake air temperature is considered as one plan to raise control accuracy of the air-fuel ratio in the lean mode.

However, the appropriate value of the intake air temperature varies according to the operating mode of the internal combustion engine. As a result of research, it is revealed that the intake air temperature suitable for the lean mode is lower than the intake air temperature suitable for the stoichiometric mode, which will be discussed later in detail. For controlling the intake air temperature to the suitable value in accordance with the operation mode, the intake air temperature is required to be lowered corresponding to switching from the stoichiometric mode to the lean mode. However, it takes a time to lower the intake air temperature whereas it can be accomplished immediately to raise the intake air temperature. Thus, at the time of switching from the stoichiometric to the lean mode, a disagreement will be produced in a relation between the SA-CA10 and the air-fuel ratio due to a delay of a reduction in the intake air temperature.

The higher the intake air temperature, the leaner the limit air-fuel ratio at which lean combustion is available becomes. This is because combustibility of fuel improves as the intake air temperature, that is the temperature in the combustion chamber, becomes high. Thus, when a delay of a reduction in the intake air temperature occurs as described above, the air-fuel ration obtained by fuel injection amount control based on the SA-CA10 becomes leaner than an air-fuel ratio as a target. Making the air-fuel ratio leaner appears to lead to improvement of fuel economy. However, the combustible improvement obtained thereby is only temporary, and the lean limit air-fuel ratio decreases surely in accordance with a reduction in the intake air temperature. Therefore, if the air-fuel ratio is made leaner than required in accordance with temporary combustible improvement, instability of combustion might be invited when the intake air temperature decreases.

The present disclosure has been conceived in view of the above described problem, and an object of the present disclosure is to provide an internal combustion engine that can prevent the air-fuel ratio from being made leaner than required in accordance with temporary combustible improvement due to a delay of a reduction in the intake air temperature after switching from the stoichiometric mode to the lean mode.

An internal combustion engine according to the present disclosure is an internal combustion engine which, in accordance with an operating region, switches between a stoichiometric mode in which operation is performed at a theoretical air-fuel ratio and a lean mode in which operation is performed at an air-fuel ratio that is leaner in fuel than the theoretical air-fuel ratio, and comprises the following apparatuses and sensors.

The internal combustion engine according to the present disclosure comprises: an intake air temperature adjustment apparatus that adjusts a temperature of intake air that enters a combustion chamber; a fuel injection apparatus that injects fuel into the combustion chamber or an intake port; a combustion pressure sensor that outputs a signal corresponding to a combustion pressure in the combustion chamber; a crank angle sensor that outputs a signal corresponding to a crank angle; and a control apparatus. The control apparatus is configured to take in signals from at least the combustion pressure sensor and the crank angle sensor and to operate at least the intake air temperature adjustment apparatus and the fuel injection apparatus.

Particularly, the control apparatus is configured to calculate a crank angle period from an ignition timing until a crank angle at which a mass fraction burned becomes a predetermined ratio (hereunder, referred to as “controlled object crank angle period”) based on a signal of the combustion pressure sensor and a signal of the crank angle sensor, and to adjust a fuel injection amount of the fuel injection apparatus so that the controlled object crank angle period coincides with a target crank angle period. Further, this control apparatus is configured to operate the intake air temperature adjustment apparatus so that the intake air temperature enters a first temperature region when the internal combustion engine operates in the stoichiometric mode, and to operate the intake air temperature adjustment apparatus so that the intake air temperature enters a second temperature region which is a lower temperature region than the first temperature region when the internal combustion engine operates in the lean mode. Further, this control apparatus is configured so that, until the intake air temperature enters the second temperature region after switching from the stoichiometric mode to the lean mode, the control apparatus shortens the target crank angle period than after the intake air temperature enters the second temperature region.

According to the above configuration, the intake air temperature decreases from a temperature in the first temperature region to a temperature in the second temperature region after switching from the stoichiometric mode to the lean mode. And, meanwhile, adjustment of the fuel injection amount is performed so that the controlled object crank angle period coincides with the target crank angle period. A correlation is established between the controlled object crank angle period and an air-fuel ratio, and is influenced by the intake air temperature. The higher the intake air temperature, the leaner the air-fuel ratio corresponding to the same controlled object crank angle period. However, according to the above configuration, while the intake air temperature decreases from a temperature in the first temperature region to a temperature in the second temperature region, the target crank angle period is shortened than that after the intake air temperature enters the second temperature region. As a result, the air-fuel ratio is prevented from being made leaner than required.

The first temperature region may be a temperature region that is defined by an error range centering on a first temperature. The second temperature region may be a temperature region that is defined by an error range centering on a second temperature that is lower than the first temperature. Further, errors that define the respective temperature regions may be taken as zero. That is, the control apparatus may be configured to operate the intake air temperature adjustment apparatus so that the intake air temperature becomes the first temperature when the internal combustion engine operates in the stoichiometric mode, and to operate the intake air temperature adjustment apparatus so that the intake air temperature becomes the second temperature that is lower than the first temperature when the internal combustion engine operates in the lean mode.

Further, the control apparatus may be configured so that, until the intake air temperature enters the second temperature region after switching from the stoichiometric mode to the lean mode, the control apparatus extends the target crank angle period in accordance with a decrease in the intake air temperature. According to this, while the intake air temperature decreases from a temperature in the first temperature region to a temperature in the second temperature region, almost the same air-fuel ratio as that after the intake air temperature enters the second temperature region can be obtained.

As described above, according to the internal combustion engine according to the present disclosure, until the intake air temperature enters the second temperature region after switching from the stoichiometric mode to the lean mode, the target crank angle period is shortened than after the intake air temperature enters the second temperature region, and thereby the air-fuel ratio can be prevented from being made leaner than required in accordance with temporary combustible improvement due to a delay of a reduction in the intake air temperature.

### BRIEF DESCRIPTION OF DRAWINGS

FIG. 1 is a conceptual diagram illustrating the overall configuration of an internal combustion engine of an embodiment;

FIG. 2 is a view that illustrates the configuration around a combustion chamber of the internal combustion engine of the embodiment;

FIG. 3 is a view for describing fuel injection amount control and ignition timing control of the embodiment;

FIG. 4 is a view illustrating the influence of intake air temperature on air-fuel ratio caused by the fuel injection amount control based on SA-CA10;

FIG. 5 is a view illustrating an image of a map in which respective target values for intake air temperature and engine water temperature are associated with engine speed and torque;

FIG. 6 is a time chart illustrating variation of engine water temperature and intake air temperature after a change of an operation mode;

FIG. 7 is a view illustrating an image of a map for determining a correction amount of a target SA-CA10 from intake air temperature;

FIG. 8 is a flowchart that illustrates a control flow of the fuel injection amount control of the embodiment; and

FIG. 9 is a time chart illustrating one example of operations of the internal combustion engine when the fuel injection amount control of the embodiment is executed with intake air temperature control, engine water temperature control and the ignition timing control.

### DETAILED DESCRIPTION

Embodiments of the present disclosure are described hereunder with reference to the accompanying drawings.

### 1. Overall Configuration of Internal Combustion Engine

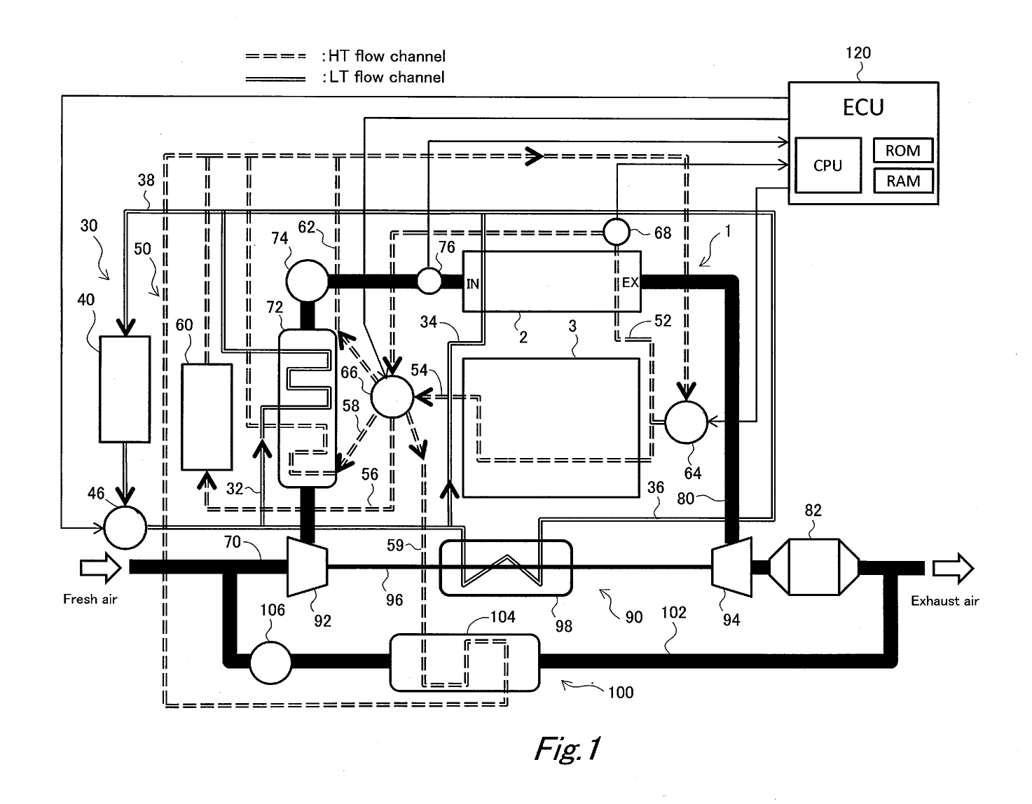

FIG. 1 is a conceptual diagram illustrating the overall configuration of an internal combustion engine of an embodiment. An internal combustion engine (hereunder, referred to simply as “engine”) 1 includes an engine block 3, and an engine head 2 that is arranged via an unshown gasket on the engine block 3.

An intake passage 70 and an exhaust passage 80 are connected to the engine head 2. A compressor 92, an intercooler 72 and an electronically controlled throttle 74 are arranged in that order in the intake passage 70 from the upstream side thereof towards the engine head 2. In the intake passage 70 on the downstream side relative to the throttle 74, an intake-air temperature sensor 76 is installed for measuring the temperature of intake air that is introduced into the engine head 2. In the exhaust passage 80, a turbine 94 and a three-way catalyst 82 are disposed in that order in the downstream direction from the engine head 2. An unshown NOx storage-reduction catalyst (NSR) and selective reduction catalyst (SCR) are disposed in that order at positions that are further downstream in the exhaust passage 80.

The compressor 92 and the turbine 94 constitute a turbocharger 90. The compressor 92 and the turbine 94 are connected by a rotating shaft 96 that is rotatably supported by a bearing 98 and rotate as one body. Although not illustrated in the drawings, a turbine bypass passage that bypasses the turbine 94 and a waste gate valve that opens and closes the turbine bypass passage are provided in the exhaust passage 80.

The engine 1 includes an EGR apparatus 100 that recirculates some of the exhaust gas from the exhaust passage 80 to the intake passage 70. The EGR apparatus 100 is constituted by an EGR passage 102, an EGR cooler 104 and an EGR valve 106. The EGR passage 102 connects the exhaust passage 80 at a position downstream of the three-way catalyst 82 to the intake passage 70 at a position upstream of the compressor 92. The EGR cooler 104 is provided in the EGR passage 102, and cools exhaust gas (EGR gas) that flows through the EGR passage 102. The EGR valve 106 is provided in the EGR passage 102 at a position that is downstream of the EGR cooler 104 in the direction of the flow of the EGR gas.

The engine 1 includes two cooling systems 30 and 50 which cool the main body and the components of the engine 1. The cooling systems 30 and 50 are each configured as a closed circuit in which cooling water circulates, and the temperature of the cooling water circulating in the cooling system 30 and the temperature of the cooling water circulating in the cooling system 50 can be made to differ from each other. Hereunder, the cooling system 30 in which cooling water of a comparatively low temperature is circulated is referred to as “LT cooling system”, and the cooling system 50 in which cooling water of a comparatively high temperature is circulated is referred to as “HT cooling system”. Further, cooling water that circulates through a circuit in the LT cooling system 30 is referred to as “LT cooling water”, and cooling water that circulates through a circuit in the HT cooling system 50 is referred to as “HT cooling water”. In FIG. 1, flow channels (hereunder, referred to as “LT flow channels”) for LT cooling water which constitute the LT cooling system 30 are depicted with double lines, and flow channels (hereunder, referred to as “HT flow channels”) for HT cooling water which constitute the HT cooling system 50 are depicted with double broken lines. Note that “LT” is an abbreviation of “low temperature” and “HT” is an abbreviation of “high temperature”.

The LT cooling system 30 includes a first LT flow channel 32 to a fourth LT flow channel 38 that constitute a circulation circuit for the LT cooling water, and an electric water pump 46 for causing the LT cooling water to circulate. The first LT flow channel 32 passes through the inside of the intercooler 72, the second LT flow channel 34 passes though the intake side in the engine head 2, and the third LT flow channel 36 passes though the bearing 98 of the turbocharger 90. Both ends of each of the first LT flow channel 32 to third LT flow channel 36 are connected in parallel to both ends of the fourth LT flow channel 38. A radiator 40 is disposed in the fourth LT flow channel 38. The fourth LT flow channel 38 forms a circuit in which LT cooling water circulates with each of the first LT flow channel 32 to the third LT flow channel 36. The electric water pump 46 is provided downstream of the radiator 40 in the fourth LT flow channel 38. The discharge rate of the electric water pump 46, that is, the flow rate of LT cooling water circulating in the circuit, can be arbitrarily changed by adjusting the output of a motor.

The LT cooling water that flows through the first LT flow channel 32 exchanges heat inside the intercooler 72 with intake air that passes through the intercooler 72. The second LT flow channel 34 is provided so as to pass through the vicinity of an intake port (preferably so as to surround the intake port) of each cylinder in the engine head 2. The LT cooling water that flows through the second LT flow channel 34 exchanges heat through the engine head 2 with intake air that passes through the intake ports. If the temperature of the LT cooling water is lower than the temperature of the intake air, the intake air is cooled by the heat exchange, while if the temperature of the LT cooling water is higher than the temperature of the intake air, the intake air is heated by the heat exchange. Thus, the temperature of intake air that enters a combustion chamber is adjusted in accordance with the temperature of the LT cooling water by the heat exchange at these sites. The LT cooling water that flows through the third LT flow channel 36 exchanges heat with the bearing 98 of the turbocharger 90, and thereby suppresses overheating of the bearing 98.

Note that, although in the present embodiment the first LT flow channel 32 and the second LT flow channel 34 are connected in parallel, the first LT flow channel 32 and the second LT flow channel 34 may be connected in series. That is, a flow channel may be provided so that LT cooling water that passed through the intercooler 72 passes though the intake side in the engine head 2. Similarly, the third LT flow channel 36 that passes through the bearing 98 also may be connected in series with the first LT flow channel 32 or the second LT flow channel 34.

The HT cooling system 50 includes a first HT flow channel 52 to a sixth HT flow channel 62 that constitute a circulation circuit for HT cooling water, an electric water pump 64 for causing HT cooling water to circulate, and a multifunction valve 66 for controlling the flow of the HT cooling water inside the circulation circuit. The first HT flow channel 52 passes through the exhaust side inside the engine head 2, and the second HT flow channel 54 passes through the inside of the engine block 3. The first HT flow channel 52 and the second HT flow channel 54 are respectively connected to separate intake ports of the multifunction valve 66.

The multifunction valve 66 has two intake ports and four discharge ports. The configuration of the multifunction valve 66 will be described in detail later. The third HT flow channel 56 to the sixth HT flow channel 62 are connected to the four discharge ports of the multifunction valve 66. A radiator 60 is disposed in the third HT flow channel 56. The fourth HT flow channel 58 passes through the inside of the intercooler 72. The fifth HT flow channel 59 passes through the inside of the EGR cooler 104. The sixth HT flow channel 62 bypasses the radiator 60, the intercooler 72 and the EGR cooler 104. The third HT flow channel 56 to sixth HT flow channel 62 are connected to an intake port of the electric water pump 64. The first HT flow channel 52 and the second HT flow channel 54 are connected to a discharge port of the electric water pump 64. Thus, a circuit in which the HT cooling water circulates is formed by the first HT flow channel 52 and the second HT flow channel 54, and by the third HT flow channel 56 to sixth HT flow channel 62. The flow rate of HT cooling water circulating inside the circuits can be arbitrarily changed by adjusting the output of a motor of the electric water pump 64.

Among the flow channels forming the circulation circuits for the HT cooling water, the flow channels in which heat exchange is performed with the main body or components of the engine 1 are the first HT flow channel 52, the second HT flow channel 54, the fourth HT flow channel 58 and the fifth HT flow channel 59. The first HT flow channel 52 is provided so as to pass through the vicinity of the wall surface on the exhaust side of the combustion chamber of each cylinder in the engine head 2. In contrast to the aforementioned second LT flow channel 34 which is locally provided in the vicinity of the intake ports, the first HT flow channel 52 is provided so as to pass through the entire engine head 2 and finally exit to outside of the engine head 2 from the exhaust side. An engine water temperature sensor 68 for measuring the temperature of HT cooling water at an outlet from the engine head 2 is provided in the outlet of the first HT flow channel 52 from the engine head 2. A temperature that is measured by the engine water temperature sensor 68 corresponds to the wall surface temperature on the exhaust side of the combustion chamber. The second HT flow channel 54 constitutes a principal part of a water jacket surrounding the peripheral walls of cylinders formed in the engine block 3 and performs overall cooling with respect to the peripheral walls of the cylinders. The fourth HT flow channel 58 exchanges heat inside the intercooler 72 with intake air that passes through the intercooler 72. In contrast to the aforementioned first LT flow channel 32 which is provided on the downstream side in the flow direction of intake air inside the intercooler 72, the fourth HT flow channel 58 is provided on the upstream side in the flow direction of the intake air inside the intercooler 72. That is, in the intercooler 72, first, heat exchange is performed between the HT cooling water and intake air, and next heat exchange is performed between the LT cooling water and the intake air. The fifth HT flow channel 59 exchanges heat inside the EGR cooler 104 with EGR gas that passes through the EGR cooler 104.

The multifunction valve 66 regulates a ratio between the flow rates of HT cooling water flowing into the two intake ports, that is, a ratio between the HT cooling water flowing through the first HT flow channel 52 and the HT cooling water flowing through the second HT flow channel 54, based on the temperature of the HT cooling water in the circulation circuit (the engine water temperature measured by the engine water temperature sensor 68). For example, at a time of cold starting when the temperature of the HT cooling water is low, the multifunction valve 66 cuts off circulation of HT cooling water through the second HT flow channel 54 that passes through the engine block 3, and allows only the circulation of HT cooling water through the first HT flow channel 52 that passes through the engine head 2. Further, the multifunction valve 66 regulates a ratio between the flow rates of HT cooling water flowing out from the four discharge ports, that is, the ratio between the HT cooling water flowing through the third HT flow channel 56, the HT cooling water flowing through the fourth HT flow channel 58, the HT cooling water flowing through the fifth HT flow channel 59 and the HT cooling water flowing through the sixth HT flow channel 62, based on the temperature of the HT cooling water. For example, at a time of cold starting when the temperature of the HT cooling water is low, the multifunction valve 66 cuts off circulation through the third HT flow channel 56 in which the radiator 60 is disposed, and causes the HT cooling water to circulate through the fourth HT flow channel 58 or sixth HT flow channel 62.

The engine 1 includes a control apparatus 120. The control apparatus 120 controls operation of the engine 1 by controlling various apparatuses and actuators included in the engine 1. The control apparatus 120 is an ECU (electronic control unit) having at least one CPU, at least one ROM and at least one RAM. However, the control apparatus 120 may be constituted by a plurality of ECUs. Various functions relating to engine control are realized in the control apparatus 120 by loading a program that is stored in the ROM to the RAM, and executing the program with the CPU.

### 2. Operation of Cooling Systems

The objects of operation by the control apparatus 120 include the two cooling systems 30 and 50. Operations of the two cooling systems 30 and 50 are performed to control the temperature of intake air that is supplied from the intake passage 70 to the engine head 2 and enters the combustion chambers. That is, the control apparatus 120 operates the cooling systems 30 and 50 by taking the temperature of intake air entering a combustion chamber as a first controlled variable (state quantity to be controlled).

Specifically, when the intake air temperature is a high temperature, such as during turbocharging by the turbocharger 90, the control apparatus 120 operates the cooling systems 30 and 50 so as to cool the intake air by means of the intercooler 72. More specifically, the control apparatus 120 operates the electric water pump 46 of the LT cooling system 30 so as to adjust the flow rate of the LT cooling water that flows through the first LT flow channel 32, and also operates the multifunction valve 66 of the HT cooling system 50 so as to cut off circulation to the fourth HT flow channel 58 of HT cooling water that has a high temperature (HT cooling water which was not cooled at the radiator 60) that flowed out from the engine head 2 or the engine block 3. By these operations, the amount of cooling of the intake air that passes through the intercooler 72 is increased or decreased in accordance with an increase or decrease in the flow rate of the LT cooling water flowing through the first LT flow channel 32, thereby adjusting the temperature of the intake air. Note that, when passing through the intake port in the engine head 2, the intake air that was cooled at the intercooler 72 is also cooled by heat exchange with LT cooling water flowing through the second LT flow channel 34.

Conversely, when the intake air temperature is low, such as at a time of cold starting, the control apparatus 120 operates the multifunction valve 66 of the HT cooling system 50 so as to allow circulation of HT cooling water to the fourth HT flow channel 58. Intake air that passes through the intercooler 72 is heated by the HT cooling water having a high temperature that flows through the fourth HT flow channel 58, and intake air whose temperature was increased by being heated in that manner flows out from the intercooler 72. Further, as operation with respect to the LT cooling system 30, the control apparatus 120 stops the electric water pump 46 to cut off the flow of LT cooling water (LT cooling water having a low temperature that was cooled at the radiator 40) to the first LT flow channel 32. By these operations, the amount of heating of the intake air that passes through the intercooler 72 is increased or decreased in accordance with an increase or decrease in the flow rate of the HT cooling water flowing through the fourth HT flow channel 58, thereby adjusting the temperature of the intake air.

As described in the foregoing, in the engine 1, operation of the cooling systems 30 and 50 is performed by taking the temperature of intake air entering the combustion chambers as a controlled variable. This operation relates to operation with respect to an “intake air temperature adjustment apparatus” described in claim 1 of the present application. In this embodiment, an apparatus constituted by the intercooler 72 and the LT cooling system 30 or the HT cooling system 50 corresponds to the “intake air temperature adjustment apparatus” described in claim 1. More specifically, when the intake air temperature is high, such during turbocharging, in the intercooler 72 the intake air is cooled by heat exchange with LT cooling water supplied by the LT cooling system 30. Hence, in such a case, an apparatus constituted by the intercooler 72 and the LT cooling system 30 corresponds to the “intake air temperature adjustment apparatus” described in claim 1. On the other hand, when the intake air temperature is low, such as at a time of cold starting, in the intercooler 72 the intake air is heated by heat exchange with HT cooling water supplied by the HT cooling system 50. Hence, in such a case, an apparatus constituted by the intercooler 72 and the HT cooling system 50 corresponds to the “intake air temperature adjustment apparatus” described in claim 1.

Further, the control apparatus 120 also performs operation of the HT cooling system 50 taking the temperature of cooling water flowing through the exhaust side of the engine head 2 (hereunder, this temperature is also referred to as “engine water temperature”) as a second controlled variable. The temperature of the cooling water flowing through the exhaust side of the engine head 2 is represented by a temperature measured by the engine water temperature sensor 68 provided at the outlet of the engine head 2. If there is a difference between the temperature measured by the engine water temperature sensor 68 and a target temperature, the control apparatus 120 operates the electric water pump 64 to adjust the flow rate of HT cooling water flowing through the first HT flow channel 52, and also operates the multifunction valve 66 to adjust the ratio of the HT cooling water that flows to the third HT flow channel 56 and is cooled at the radiator 60. By these operations, the temperature of cooling water that flows through the exhaust side of the engine head 2 is adjusted in accordance with an increase or decrease in the flow rate of the HT cooling water flowing through the first HT flow channel 52 or in accordance with an increase and decrease in the ratio of HT cooling water that is cooled at the radiator 60.

### 3. Configuration Around Combustion Chamber

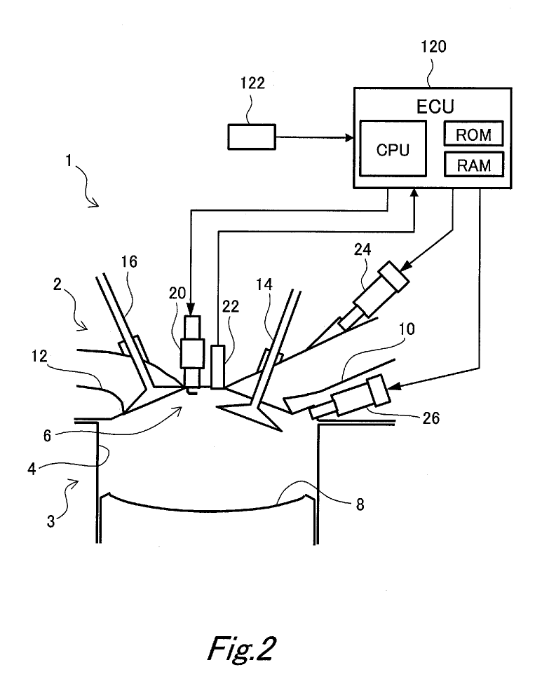

Next, the configuration around a combustion chamber of the engine 1 will be described using FIG. 2. In FIG. 2, components constituting the engine 1 are illustrated in a manner in which the components are projected onto a single plane that is perpendicular to a crankshaft. The engine 1 is a spark-ignition multi-cylinder engine that has a plurality of cylinders 4. The number and arrangement of the cylinders 4 is not limited. In each of the cylinders 4 of the engine block 3, a piston 8 is arranged that reciprocates in the axial direction thereof. A pent-roof shaped combustion chamber 6 that is an upper space of the cylinder 4 is formed on the underside of the engine head 2.

An intake port 10 and an exhaust port 12 that communicate with the combustion chamber 6 are formed in the engine head 2. An intake valve 14 is provided at an opening portion that allows the intake port 10 to communicate with the combustion chamber 6. An exhaust valve 16 is provided at an opening portion that allows the exhaust port 12 to communicate with the combustion chamber 6. Although not illustrated in the drawing, the intake port 10 bifurcates partway along its length in the direction from an inlet formed in a side face of the engine head 2 towards the opening portion that communicates with the combustion chamber 6. A port injection valve 24 that injects fuel into the intake port 10 is provided upstream of a portion at which the intake port 10 bifurcates. At a lower part of the intake port 10 which is a location between the bifurcating parts of the intake port 10, an in-cylinder injection valve 26 that injects fuel into the combustion chamber 6 is provided so that the tip thereof faces the combustion chamber 6. The port injection valve 24 and the cylinder injection valve 26 constitute a fuel injection apparatus. Further, a spark plug 20 that constitutes an injection apparatus and a combustion pressure sensor 22 for measuring a combustion pressure are provided in the vicinity of the top portion of the combustion chamber 6.

The engine 1 is an engine that is capable of switching between operation in a lean mode and operation in a stoichiometric mode. In the lean mode, operation is performed according to an air-fuel ratio that is lean in fuel (for example, an air-fuel ratio of around 25), that is operation using lean combustion, by port injection with which an air-fuel mixture having a high degree of homogeneity is obtained, or by a combination of port injection and in-cylinder injection that primarily uses the port injection. More specifically, lean combustion that is realized with the engine 1 is not stratified lean combustion which forms an air-fuel mixture layer with a high fuel concentration at the periphery of the spark plug 20, but rather is homogeneous lean combustion which distributes an air-fuel mixture with a homogeneous fuel concentration throughout the combustion chamber 6. Further, in the lean mode, introduction of EGR gas is not performed by the EGR apparatus 100, and lean combustion is performed that uses only fresh air. In the stoichiometric mode, operation according to the theoretical air-fuel ratio is performed, that is, operation is performed under stoichiometric combustion, by in-cylinder injection or by a combination of port injection and in-cylinder injection that primarily uses the in-cylinder injection. However, the term “operation according to the theoretical air-fuel ratio” does not mean that the air-fuel ratio under which operation is performed is necessarily always the exact theoretical air-fuel ratio. In the present description, operation in which the operational air-fuel ratio deviates somewhat to the rich side or lean side relative to the theoretical air-fuel ratio and operation in which the operational air-fuel ratio fluctuates with small amplitude around the theoretical air-fuel ratio are included in the meaning of the term “operation according to the theoretical air-fuel ratio”. The stoichiometric mode is selected in an operating region in which the load is high relative to an operating region in which the lean mode is selected. Further, in the stoichiometric mode of the present embodiment, EGR is executed by the EGR apparatus 100. Therefore, in the following description, the stoichiometric mode in which EGR is executed is, in particular, referred to as “stoichiometric EGR mode” to distinguish the mode from the lean mode in which EGR is not executed.

Operations of the apparatuses and actuators for realizing the lean mode and the stoichiometric EGR mode are performed by the control apparatus 120. Combustion pressure data obtained by the combustion pressure sensor 22 is taken in by the control apparatus 120. The combustion pressure data is used together with crank angle signals taken in from a crank angle sensor 122 to perform fuel injection amount control and ignition timing control that are described next. Note that, when the control apparatus 120 is constituted by a plurality of ECUs, an ECU that performs fuel injection amount control or ignition timing control may be a separate ECU from an ECU that performs intake air temperature control or engine water temperature control that are described above.

### 4. Fuel Injection Amount Control and Ignition Timing Control Based on Combustion Pressure Data

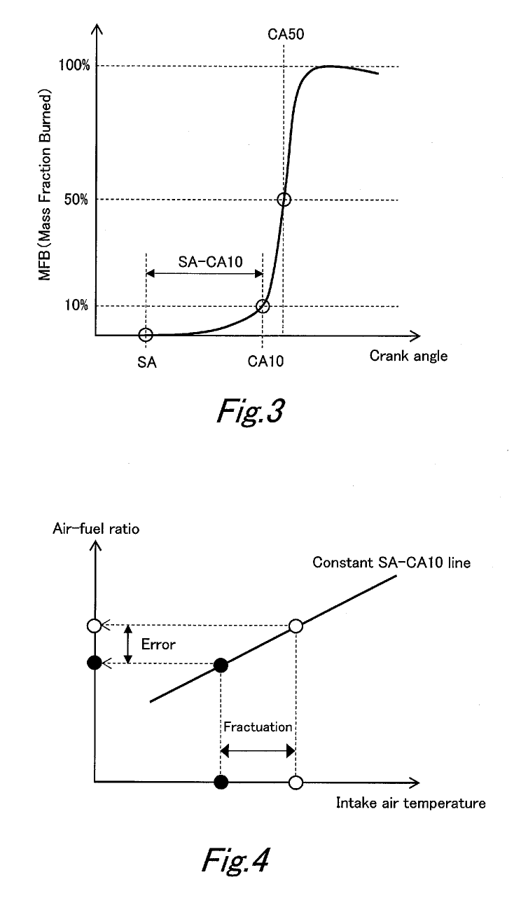

During operation in the lean mode, the control apparatus 120 performs fuel injection amount control and ignition timing control based on combustion pressure data obtained by the combustion pressure sensor 22. Hereunder, the details of the control are described using FIG. 3.

The control apparatus 120 calculates a heat release quantity Q in a cylinder at an arbitrary crank angle θ in accordance with expression (1) using in-cylinder pressure data obtained by the combustion pressure sensor 22. Where, in expression (1), P represents an in-cylinder pressure, V represents an in-cylinder volume and κ represents a ratio of specific heat of in-cylinder gas. Further, P₀ and V₀ represent an in-cylinder pressure and an in-cylinder volume, respectively, at a calculation starting point θ₀ (a predetermined crank angle during a compression stroke that is defined so as to include a margin with respect to an assumed combustion starting point).

$$Q = \int PdV + \frac{1}{κ - 1} ( PV - {P}_{0} {V}_{0} ) \qquad ( 1 )$$

After the heat release quantity Q has been calculated at each crank angle θ of a predetermined crank angle period that includes a combustion period, next a mass fraction burned (hereunder, referred to as “MFB”) at an arbitrary crank angle θ is calculated in accordance with expression (2). Where, in expression (2), θₛₜₐ represents a combustion starting point and θ_{fin} represents a combustion ending point.

$$MFB = \frac{Q ( θ ) - Q ( {θ}_{Sta} )}{Q ( {θ}_{fin} ) - Q ( {θ}_{sta} )} \qquad ( 2 )$$

FIG. 3 is a view that illustrates a waveform of MFB with respect to the crank angles calculated according to the above described expression (2). A SA-CA10 that is defined as a crank angle period until a crank angle CA10 at which MFB becomes 10% after ignition of an air-fuel mixture is performed at an ignition timing SA is a parameter that represents an ignition delay, and it is known that there is a high correlation between SA-CA10 and the air-fuel ratio of the air-fuel mixture that is combusted (particularly, a limit air-fuel ratio at which lean combustion is possible). If the fuel injection amount is subjected to feedback control so that SA-CA10 becomes a target value, the air-fuel ratio can be naturally brought close to the target air-fuel ratio (lean limit air-fuel ratio). In the fuel injection amount control by the control apparatus 120, the actual SA-CA10 is calculated based on the MFB waveform, and the fuel injection amount is corrected based on a difference between a target SA-CA10 and the actual SA-CA10. Note that, because the time period per crank angle changes when the engine speed changes, preferably the target SA-CA10 is set in accordance with the engine speed at least.

A crank angle CA50 at a time at which the MFB becomes 50% corresponds to the combustion center of gravity position. The crank angle CA50 changes depending on the ignition timing SA. If CA50 matches the combustion center of gravity position at a time that the torque that is realized is the maximum torque, it can be said that the ignition timing SA at such time is the MBT. In the ignition timing control by the control apparatus 120, the actual CA50 is calculated based on the MFB waveform, and the basic ignition timing is corrected based on a difference between the target CA50 and the actual CA50. The target CA50 is also preferably set in accordance with at least the engine speed.

As described in the foregoing, according to the present embodiment, SA-CA10 and CA50 are calculated based on combustion pressure data obtained by the combustion pressure sensor 22, and fuel injection amount control is performed based on SA-CA10, and ignition timing control is performed based on CA50. Note that, although fuel injection amount control based on SA-CA10 can be performed regardless of the operation mode, in the present embodiment the fuel injection amount control based on SA-CA10 is performed during operation in the lean mode. During operation in the stoichiometric EGR mode, air-fuel ratio feedback control is performed based on the output of an unshown air-fuel ratio sensor or oxygen concentration sensor.

In this connection, fuel injection amount control based on SA-CA10 is based on the premise that there is a strong correlation between SA-CA10 and the air-fuel ratio. However, research carried out by the inventors of the present application revealed that the temperature of intake air that enters the combustion chamber 6 is a parameter that has a particularly strong influence on the relation between SA-CA10 and the air-fuel ratio among the various parameters relating to combustion.

FIG. 4 is a view illustrating the manner in which the air-fuel ratio changes depending on the temperature of intake air that enters the combustion chamber 6 when the fuel injection amount is controlled so that SA-CA10 is constant. As illustrated in FIG. 5, when the temperature of intake air is comparatively low the air-fuel ratio is controlled to a comparatively small value (that is, a fuel-rich value), and when the temperature of intake air is comparatively high the air-fuel ratio is controlled to a comparatively large value (that is, a fuel-lean value). That is, an error arises between the target air-fuel ratio and the actual air-fuel ratio according to fluctuations in the temperature of intake air.

Therefore, in the intake air temperature control according to the present embodiment, operation of the cooling systems 30 and 50 is performed so as to actively make the temperature of intake air that enters the combustion chamber 6 that is a controlled variable a constant temperature.

### 5. Setting of Intake Air Temperature and Engine Water Temperature

It is required to make the intake air temperature constant in order to ensure the accuracy of fuel injection amount control based on SA-CA10. However, since the intake air temperature is itself a parameter that influences combustion, it is not the case that the intake air temperature that is adopted as a target may be any temperature. Further, the engine water temperature (temperature of cooling water that flows through the exhaust side of the engine head 2) that is a controlled variable of the engine water temperature control is also a parameter that influences combustion. Hence, it is preferable that there are no fluctuations in the engine water temperature also, similarly to the intake air temperature.

Tasks that exist with respect to the lean mode and the stoichiometric EGR mode when considering the setting of the intake air temperature and engine water temperature that are to be adopted as targets are summarized and described hereunder.

At least the following three tasks exist with respect to the lean mode. The first task is to improve the robustness of combustion. This task arises due to the fact that because the fuel concentration in the air-fuel mixture is low overall in homogeneous lean combustion, in comparison to stoichiometric combustion or stratified lean combustion, many constraints exist with regard to disturbance in terms of maintaining combustion. The second task is to reduce the generation of unburned hydrocarbons. This task arises due to the fact that because the combustion temperature in lean combustion is low compared to stoichiometric combustion, unburned hydrocarbons are liable to be generated from the quench area of the combustion chamber 6. The third task is to increase the upper-limit air amount. To further improve fuel consumption performance, it is required to increase the upper-limit air amount and expand the operation region of the lean mode to the high load side.

At least the following three tasks exist with respect to the stoichiometric EGR mode. The first task is to improve the robustness of combustion. This task arises due to the fact that, in the stoichiometric EGR mode, if a large amount of EGR gas is introduced to improve fuel consumption, combustion is liable to become unstable since there are fluctuations in the EGR amount that is introduced between each cycle. The second task is to suppress the generation of condensed water caused by condensation of water vapor that is contained in EGR gas. This task arises due to the fact that because sulfur components and hydrocarbon components are contained in EGR gas, condensed water acidifies if these components melt in the condensed water, and there is a concern that the condensed water will corrode or deteriorate the engine 1. The third task is to suppress the occurrence of knocking at the time of a high load. This task arises due to the fact that when the load increases, the compression-end temperature increases and knocking is liable to occur.

As the result of studies conducted while taking the above tasks into consideration, in the present embodiment a configuration is adopted in which the respective target values for the intake air temperature (temperature of intake air entering the combustion chamber 6) and for the engine water temperature (temperature of cooling water flowing through the exhaust side of the engine head 2) in the lean mode and the stoichiometric EGR mode, respectively, are set as described hereunder.

First, setting of a target value of the intake air temperature will be described. Among the above described tasks, the tasks that particularly relate to the intake air temperature in the stoichiometric EGR mode are the first task and second task for the stoichiometric EGR mode, and the tasks that particularly relate to the intake air temperature in the lean mode are the first task and third task for the lean mode. The target value for the intake air temperature in each mode is set to an optimal intake air temperature for comprehensively achieving these tasks.

The optimal intake air temperature (first temperature) of the stoichiometric EGR mode in this embodiment is 45° C. This temperature is a temperature that corresponds to a dew-point temperature in standard operating conditions (these operating conditions include air pressure, outside air temperature, humidity, EGR rate and the like). In the stoichiometric EGR mode the two cooling systems 30 and 50 are operated so that the intake air temperature that is measured by the intake-air temperature sensor 76 is maintained at 45° C. that is the optimal intake air temperature.

The higher that the intake air temperature is in the stoichiometric EGR mode, the better it is in terms of reducing a risk that condensed water will arise. However, the intake efficiency decreases as the intake air temperature increases. By controlling the intake air temperature to the dew-point temperature as described above, the risk of condensed water arising can be suppressed while suppressing a decrease in the intake efficiency to a minimum. However, although the dew-point temperature changes depending on the operating conditions, the target value of the intake air temperature in the stoichiometric EGR mode is fixed to the dew-point temperature under standard operating conditions. That is, even if the dew-point temperature changes, the intake air temperature is not changed in accordance with the dew-point temperature. The reason is that, when a large amount of EGR gas is introduced in the stoichiometric EGR mode and fluctuations in the EGR amount between each cycle affect combustion, if there are also fluctuations in the intake air temperature there is a risk that this will lead to unstable combustion. In short, a configuration is adopted in which the intake air temperature is maintained at a constant temperature even in the stoichiometric EGR mode in order to improve the robustness of combustion. Note that, although preferably the intake air temperature is maintained at exactly the optimal intake air temperature, an error of a certain amount (for example, around 1° C.) with respect to the optimal intake air temperature may be allowed. That is, a configuration may be adopted so as to perform adjustment of the intake air temperature so that the intake air temperature enters a temperature region (first temperature region) defined by an error range that is centered on the optimal intake air temperature.

On the other hand, the optimal intake air temperature in the lean mode is a lower temperature than the optimal intake air temperature in the stoichiometric EGR mode. In the lean mode, in which recirculation is not performed, a decrease in combustion stability due to fluctuations in the EGR amount between cycles does not arise. Therefore, intake air of a comparatively low temperature relative to the stoichiometric EGR mode can be supplied into the combustion chambers. In the present embodiment, the optimal intake air temperature (second temperature) in the lean mode is 35° C. In the lean mode, the two cooling systems 30 and 50 are operated so that the intake air temperature measured by the intake-air temperature sensor 76 is maintained at 35° C. that is the optimal intake air temperature.

By maintaining the intake air temperature at the optimal intake air temperature, the accuracy of fuel injection amount control that is based on SA-CA10 can be improved and a deviation in the air-fuel ratio with respect to the target air-fuel ratio can be suppressed. At the same time, the operating region in which operation is performed in the lean mode can be expanded to the high load side by an increase in the upper-limit air amount that is achieved by improving the intake efficiency. Note that, although preferably the intake air temperature is maintained at exactly the optimal intake air temperature, an error of a certain amount (for example, around 1° C.) with respect to the optimal intake air temperature may be allowed. That is, a configuration may be adopted so as to perform adjustment of the intake air temperature so that the intake air temperature enters a temperature region (second temperature region) defined by an error range that is centered on the optimal intake air temperature.

Next, setting of a target value of the engine water temperature will be described. Among the above described tasks, the task that particularly relates to the engine water temperature in the stoichiometric EGR mode is the third task for the stoichiometric EGR mode, and the task that particularly relates to the engine water temperature in the lean mode is the second task for the lean mode. The target value for the engine water temperature in each mode is set to an optimal engine water temperature for comprehensively achieving these tasks.

The optimal engine water temperature in the lean mode in this embodiment is 95° C. In the lean mode, the HT cooling system 50 is operated so that the engine water temperature measured by the engine water temperature sensor 68 is maintained at 95° C. that is the optimal engine water temperature.

Since the wall surface temperature of the combustion chamber 6, particularly the wall surface temperature on the exhaust side, can be raised by maintaining the engine water temperature at the optimal engine water temperature, unburned hydrocarbons that are generated from the quench area of the combustion chamber 6 can be reduced. In comparison to stoichiometric combustion, the combustion temperature is low and the exhaust gas temperature does not become high in lean combustion, and consequently it is difficult for a purification function of a catalyst to be exerted adequately. Therefore, it is required to reduce the unburned hydrocarbons themselves that are emitted from the engine 1. Note that, although preferably the engine water temperature is maintained at exactly the optimal engine water temperature, an error of a certain amount (for example, around 1° C.) with respect to the optimal engine water temperature may be allowed. That is, a configuration may be adopted so as to perform adjustment of the engine water temperature so that the engine water temperature enters a temperature region defined by an error range that is centered on the optimal engine water temperature.

On the other hand, although a temperature width exists with respect to the optimal engine water temperature in the stoichiometric EGR mode, the upper limit temperature thereof is a lower temperature than the optimal engine water temperature in the lean mode. In the stoichiometric EGR mode, because the combustion concentration is high and the exhaust gas temperature is also high, even if unburned hydrocarbons are generated from the quench area, the unburned hydrocarbons can be purified by the catalyst which functions adequately. Therefore, cooling water of a comparatively low temperature relative to the lean mode can be caused to flow to the exhaust side of the engine head. The optimal engine water temperature in the stoichiometric EGR mode in the present embodiment is a temperature within a temperature range that takes 88° C. as an upper limit temperature, that is, a temperature equal to or less than 88° C. However, the term “temperature equal to or less than 88° C.” does not mean that a temperature which is lower than 88° C. by any amount is allowed, but rather means that although 88° C. is preferable, a temperature that is lower than 88° C. to a certain extent is also allowed. In the lean mode, the HT cooling system 50 is operated so that the engine water temperature measured by the engine water temperature sensor 68 is maintained at a temperature that is equal to or less than 88° C.

The reason that the engine water temperature in the stoichiometric EGR mode is made lower than the engine water temperature in the lean mode is to inhibit the occurrence of knocking. Although unburned hydrocarbons that are generated from the quench area of the combustion chamber 6 are liable to increase when the engine water temperature is lowered, the unburned hydrocarbons can be purified by the adequately functioning catalyst which receives a supply of exhaust gas having a high temperature as the result of undergoing stoichiometric combustion. Note that, although a temperature width is provided with respect to the optimal engine water temperature in the stoichiometric EGR mode, from the viewpoint of improving the robustness of combustion it is preferable to maintain the engine water temperature at a constant temperature.

The foregoing is a description that relates to the respective target values for the intake air temperature and the engine water temperature in each of the lean mode and the stoichiometric EGR mode. The respective target values for the intake air temperature and the engine water temperature which are set as described above are stored in association with the engine speed and torque in a map that is stored in the ROM of the control apparatus 120. FIG. 5 is a view illustrating an image of a map in which respective target values for the intake air temperature and the engine water temperature are associated with the engine speed and torque. In FIG. 5, the temperatures represented by “HT” are target values for the engine water temperature, and the temperatures represented by “LT” are target values for the intake air temperature. The various kinds of control of the engine 1 including the intake air temperature control and the engine water temperature control are performed according to operating regions that are set on a two-dimensional plane that adopts the engine speed and torque as axes.

In FIG. 5, a lean region in which operation according to the lean mode is performed, and a stoichiometric EGR region in which operation according to the stoichiometric EGR mode is performed are set as operating regions of the engine 1. In the lean region, as described above, the target value of the intake air temperature is set to 35° C. and the target value of the engine water temperature is set to 95° C. In the stoichiometric EGR region, the target value of the intake air temperature is set to 45° C. or more and the target value of the engine water temperature is set to 88° C. or less. The term “target value of the intake air temperature is set to 45° C. or more” means that although normally 45° C. is the target value, the intake air temperature is allowed to become higher than 45° C. in a high load region.

The intake air temperature control and engine water temperature control are executed based on respective target values for the intake air temperature and the engine water temperature that are set as described above.

### 6. Fuel Injection Amount Control at Operating Mode Switching

As described above, the control apparatus 120 controls the intake air temperature in the lean mode to 35° C. constantly in order to secure accuracy of the fuel injection amount control based on the SA-CA10. Also, as described above, the control apparatus 120 controls the intake air temperature in the stoichiometric EGR mode to 45° C. constantly. Therefore, at the time of switching from the stoichiometric EGR mode to the lean mode, it is performed to reduce the intake air temperature from 45° C. to 35° C. Specifically, when the operating point of the engine 1 moves from the stoichiometric EGR region to the lean region, the electric water pump flow rate of the LT cooling system 30 is increased in stepwise manner at the timing of switching of the operating mode so as to lower the intake air temperature from 45° C. to 35° C. At the same time, the electric water pump flow rate of the HT cooling system 50 and the opening degree of the channel connected to the radiator 60 (the opening degree of the third HT flow channel 56 of the multifunction valve 66) are decreased in stepwise manner so as to raise the engine water temperature from 88° C. or less to 95° C.

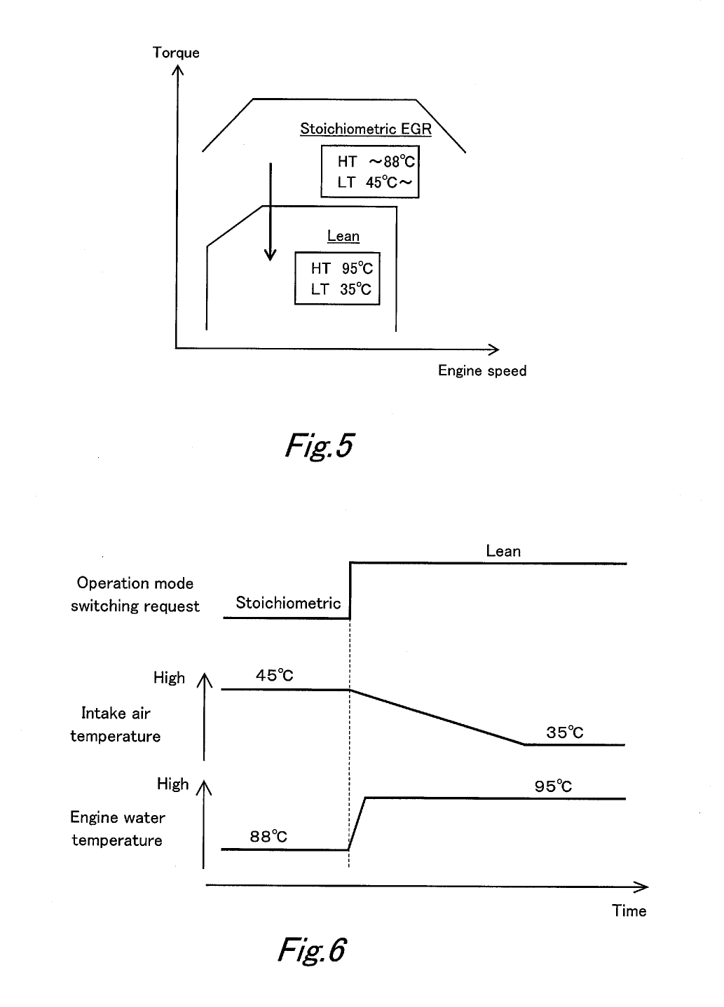

However, under an environment where a large amount of heat is radiated from the engine 1, it is easy to raise the intake air temperature and the engine water temperature, but it is not easy to reduce the intake air temperature and the engine water temperature. FIG. 6 is a time chart illustrating variation of the engine water temperature and the intake air temperature after switching of the operation mode. The response delay of the intake air temperature to the operation of the LT cooling system 30 is large whereas the engine water temperature rises with good response to the operation of the HT cooling system 50. Therefore, it takes some time until the intake air temperature falls to 35° C. from switching of the operating mode.

Until the intake air temperature falls to 35° C., a disagreement is produced in a relation between the SA-CA10 and the air-fuel ratio. Specifically, under a target SA-CA10 (target crank angle period in claim 1) that is adapted assuming that the intake air temperature is 35° C., the fuel injection amount is correctively reduced compared to the appropriate value when the intake air temperature is higher than 35° C. The air-fuel ratio actualized as a result becomes leaner in fuel than the target air-fuel ratio. The air-fuel ratio actualized by the fuel injection amount control based on the SA-CA10 is the lean limit air-fuel ratio corresponding to the intake air temperature at that time, and as the intake air temperature decreases, the lean limit air-fuel ratio decreases. Thus, as the intake air temperature decreases, the air-fuel ratio is corrected to a richer side. At that time, the air-fuel ratio exceeds the lean limit air-fuel ratio repeatedly by action of the feedback control, and thereby combustion is made unstable.

Thus, until the intake air temperature decreases to 35° C., the control apparatus 120 performs the fuel injection amount control by using the target SA-CA10 that is corrected in accordance with the current intake air temperature instead of the target SA-CA10 that is adapted based on the intake air temperature being 35° C. Specifically, a correction amount to the target SA-CA10 is set so that the higher the intake air temperature measured by the intake air temperature sensor 76, the shorter the target SA-CA10 becomes. This is because combustibility improves as the intake air temperature becomes high and thereby the SA-CA10 that is crank angle period from an ignition timing until a crank angle at which a mass fraction burned becomes 10% becomes short.

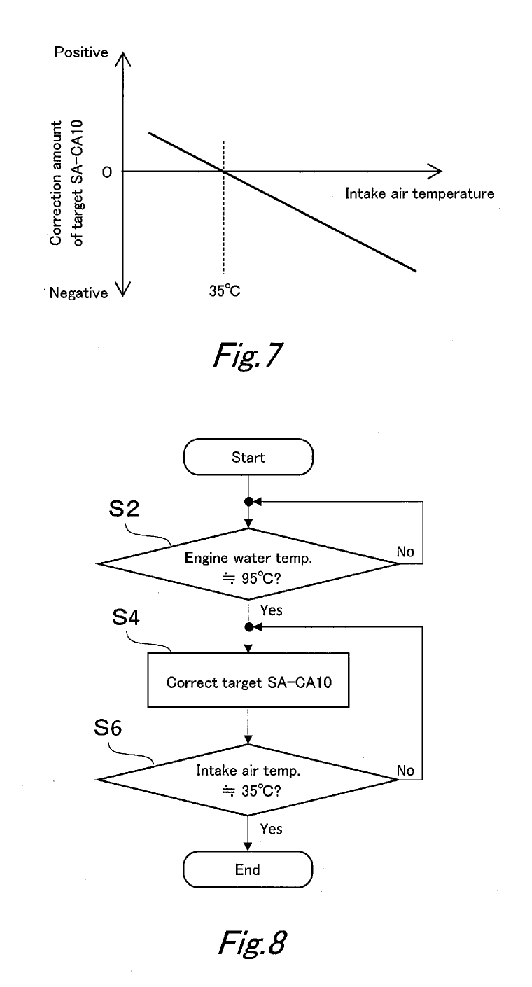

FIG. 7 is a view illustrating an image of a map for determining the correction amount of the target SA-CA10 from the intake air temperature. According to the map, the correction amount is zero when the intake air temperature is 35° C., and has a negative value when the intake air temperature is higher than 35° C., the magnitude of the negative value being large as the intake air temperature is high. Note that it is preferred that the map for determining the correction amount from the intake air temperature is prepared for at least engine speed because the target SA-CA10 is determined in accordance with at least engine speed.

FIG. 8 is a flowchart that illustrates a control flow of the fuel injection amount control that is performed at the time of switching from the stoichiometric EGR mode to the lean mode. The control apparatus 120 retrieves a program expressed with such the control flow from the ROM and performs the program.

First, in step S2, the control apparatus 120 determines whether the engine water temperature measured by the engine water temperature sensor 68 is 95° C. or a temperature in the vicinity of 95° C. The temperature in the vicinity of 95° C. means a temperature within an error range that is centered on 95° C. that is the optimal engine water temperature in the lean mode. The meaning of the determination performed in step S2 is described below in detail. First, the control apparatus 120 acquires as a switching request of the operating mode from the stoichiometric EGR mode to the lean mode the fact that the operating point of the engine 1 moves to the lean region from the stoichiometric EGR region. The control apparatus 120 operates both the cooling system 30, 50 immediately after receiving the switching request of the operating mode, and thereby reduces the intake air temperature while raising the engine water temperature. As exemplified in FIG. 6, a rise in the engine water temperature is earlier than a reduction in the intake air temperature. When the engine water temperature rises to a temperature that is suitable for the lean mode, the control apparatus 120 performs switching the operating mode to the lean mode without waiting for a reduction in the intake air temperature so that the air-fuel ratio becomes lean. A determination for this purpose is the determination performed in step S2.

When it is confirmed that the engine water temperature becomes 95° C. or a temperature in the vicinity of 95° C., the control flow advances to step S4. In step S4, the control apparatus 120 corrects the target SA-CA10. As mentioned above, the method of the correction includes calculating the correction amount of the target SA-CA10 based on the intake air temperature measured by the intake air temperature sensor 76 and correctively shortening the target SA-CA10 by the correction amount. Even if the intake air temperature is higher than 35° C., by shortening the target SA-CA10 in accordance with a gap between the intake air temperature and 35° C., the air-fuel ratio actualized by the fuel injection amount control based on the SA-CA10 is maintained in the vicinity of the target air-fuel ratio in the lean mode without being made lean more than required.

In step S6, the control apparatus 120 determines whether the intake air temperature measured by the intake air temperature sensor 76 is 35° C. or a temperature in the vicinity of 35° C. The temperature in the vicinity of 35° C. means a temperature within an error range that is centered on 35° C. that is the optimal intake air temperature in the lean mode. If the intake air temperature decreases to 35° C., correction of the target SA-CA10 can be canceled because the target SA-CA10 is adapted assuming that the intake air temperature is 35° C. that is the optimal intake air temperature. Until the intake air temperature reduces to the vicinity of 35° C., the control apparatus 120 repeatedly performs processing in step 4 that is correction of the target SA-CA10 based on the intake air temperature. Note that the processing in step S4 is performed every cycle of the engine 1. When it is confirmed that the intake air temperature becomes a temperature in the vicinity of 35° C., this control flow is finished, and normal fuel injection amount control is then performed.

### 7. Example of Operations of Engine

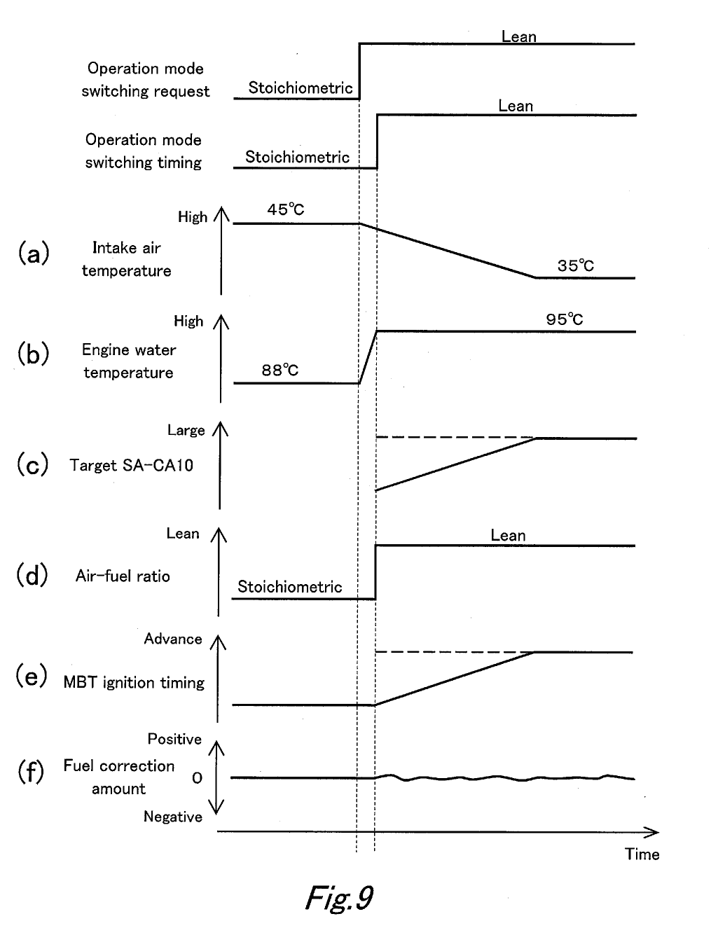

FIG. 9 is a time chart illustrating one example of operations of engine 1 when the above described fuel injection amount control is executed with the intake air temperature control, the engine water temperature control and the ignition timing control. In FIG. 9, changes with time in the following parameters are illustrated for a case where, with respect to FIG. 5, the load is decreased from the stoichiometric EGR region to the lean region while the engine speed is maintained constant. The parameters are: (a) the intake air temperature and (b) the engine water temperature that are controlled variables for the intake air temperature control and the engine water temperature control; (c) the target SA-CA10 that is a parameter relating to the fuel injection amount control; (d) the air-fuel ratio that is a parameter relating to switching of the operation mode; (e) the MBT ignition timing that is a parameter relating to the ignition timing control; and (f) the fuel correction amount that is a controlled variable for the fuel injection amount control. Also, a flag for requesting an operating mode switching and a flag indicating an operating mode switching timing are shown in the time chart.

In the stoichiometric EGR region, the air-fuel ratio is set to a stoichiometric air-fuel ratio. The turbocharging pressure is decreased in accordance with a decrease in the load. Although the temperature of intake air entering the intercooler 72 reduces in accordance with a decrease in the turbocharging pressure, the intake air temperature measured by the intake air temperature sensor 76 is maintained constant at 45° C. To realize this, the electric water pump flow rate of the LT cooling system 30 has been decreased in accordance with a decrease in the load. Further, the engine water temperature measured by the engine water temperature sensor 68 is maintained at 88° C. or less. Since cooling loss decreases in accordance with a decrease in the load, the electric water pump flow rate of the HT cooling system 50 and the opening degree of the channel connected to the radiator 60 (the opening degree of the third HT flow channel 56 of the multifunction valve 66) have been decreased in accordance with a decrease in the load so that the engine water temperature is constant.

Subsequently, when the operating point of the engine 1 moves from the stoichiometric EGR region to the lean region, the flag for requesting an operating mode switching is set. Following the fact that the flag for requesting an operating mode switching is set, the electric water pump flow rate of the HT cooling system 50 and the opening degree of the channel connected to the radiator 60 (the opening degree of the third HT flow channel 56 of the multifunction valve 66) are decreased in a step response manner, and the electric water pump flow rate of the LT cooling system 30 is increased in a step response manner. Thereby, the intake air temperature decreases from 45° C. as shown in chart (a), and the engine water temperature increases from 88° C. as shown in chart (b).

A rise in the engine water temperature is fast, and when the engine water temperature increases to the vicinity of 95° C., the flag indicating an operating mode switching timing is set. Following the fact that the flag indicating an operating mode switching timing is set, the fuel injection amount control based on the SA-CA10 is started, and setting of the target SA-CA10 is performed as shown in chart (c). In the stoichiometric EGR mode, the fuel injection amount is controlled by air-fuel ratio feedback control based on an output of an air-fuel ratio sensor or an oxygen concentration sensor so that the air-fuel ratio becomes the stoichiometric air-fuel ratio. Therefore, the target SA-CA10 is not set in the stoichiometric EGR mode.

The fuel injection amount control based on the SA-CA10 is started by switching of the operating mode. However, because the response delay of the intake air temperature to the operation of the LT cooling system 30 is large, the intake air temperature does not decrease immediately to 35° C. that is the optimal intake air temperature. Therefore, the target SA-CA10 is correctively shortened in accordance with the intake air temperature measured by the intake air temperature sensor 76. In chart (c), the broken line indicates the target SA-CA10 that is not corrected and the solid line indicates the target SA-CA10 that is corrected. The target SA-CA10 is gradually extended in accordance with a reduction in the intake air temperature, and the correction amount of the target SA-CA10 is set to zero when the intake air temperature decreases to the vicinity of 35° C. During this time, the control apparatus 120 calculates the fuel correction amount that is to be added to a basic fuel injection amount so as to make the actual SA-CA10 agree with the corrected target SA-CA10. The basic fuel injection amount is a fuel injection amount that is calculated from the target air-fuel ratio in the lean mode.

By correcting the target SA-CA10 in accordance with the intake air temperature as described above, the fuel correction amount that greatly reduces the fuel injection amount is not calculated as shown in chart (f). Thereby, the air-fuel ratio is prevented from being made leaner than required after switching of the operation mode to the lean mode, and is maintained at the target air-fuel ratio in the lean mode as shown in chart (d). Note that, in both the stoichiometric EGR mode and the lean mode, the ignition timing control is performed based on the CA50. As shown in chart (e), the MBT ignition timing in the lean mode is located in the advance side than the MBT ignition timing in the stoichiometric EGR mode, but, the MBT ignition timing during the period when the intake air temperature is higher than 35° C. is located in the retard side than the original MBT ignition timing in the lean mode. This is because combustibility improves due to the intake air temperature being high. As the intake air temperature decreases, the MBT ignition timing is corrected to the advance side.

### 8. Other Embodiments

In the above described embodiment, the SA-CA10 is used as a parameter for the fuel injection amount control, but the crank angle CA10 at which a mass fraction burned becomes 10% is an example of the end point of the controlled object crank angle period. The end point of the controlled object crank angle period may be a crank angle at which a mass fraction burned becomes a predetermined ratio, which is not limited to 10%.

What is claimed is:

1. An internal combustion engine which, in accordance with an operating region, switches between a stoichiometric mode in which operation is performed at a theoretical air-fuel ratio and a lean mode in which operation is performed at an air-fuel ratio that is leaner in fuel than the theoretical air-fuel ratio, comprising:
an intake air temperature adjustment apparatus that adjusts a temperature of intake air that enters a combustion chamber;
a fuel injection apparatus that injects fuel into the combustion chamber or an intake port;
a combustion pressure sensor that outputs a signal corresponding to a combustion pressure in the combustion chamber;
a crank angle sensor that outputs a signal corresponding to a crank angle; and
a control apparatus that takes in signals from at least the combustion pressure sensor and the crank angle sensor and operates at least the intake air temperature adjustment apparatus and the fuel injection apparatus;
wherein the control apparatus is configured to calculate a crank angle period from an ignition timing until a crank angle at which a mass fraction burned becomes a predetermined ratio based on a signal of the combustion pressure sensor and a signal of the crank angle sensor, and to adjust a fuel injection amount of the fuel injection apparatus so that the crank angle period coincides with a target crank angle period,
wherein the control apparatus is configured to operate the intake air temperature adjustment apparatus so that the temperature of intake air enters a first temperature region when the internal combustion engine operates in the stoichiometric mode, and to operate the intake air temperature adjustment apparatus so that the temperature of intake air enters a second temperature region which is a lower temperature region than the first temperature region when the internal combustion engine operates in the lean mode, and
wherein the control apparatus is configured so that, until the temperature of intake air enters the second temperature region after switching from the stoichiometric mode to the lean mode, the control apparatus shortens the target crank angle period than after the temperature of intake air enters the second temperature region.

2. The internal combustion engine according to claim 1, wherein the control apparatus is configured so that, until the temperature of intake air enters the second temperature region after switching from the stoichiometric mode to the lean mode, the control apparatus extends the target crank angle period in accordance with a decrease in the temperature of intake air.
